(19) United States
(12) Patent Application Publication
(10) Pub. No.: US 2014/0310807 A1
(43) Pub. Date: Oct. 16, 2014

(54) Cloud-based secure download method

(71) Applicants: Xiangdong Qi, Beijing (CN); Chenxi Zhao, Beijing (CN)

(72) Inventors: Xiangdong Qi, Beijing (CN); Chenxi Zhao, Beijing (CN)

(73) Assignee: BEIJING QIHOO TECHNOLOGY COMPANY LIMITED, Beijing (CN)

(21) Appl. No.: 13/885,738

(22) PCT Filed: Nov. 16, 2011
(86) PCT No.: PCT/CN2011/082280

§ 371 Date: Jul. 10, 2013

(30) Foreign Application Priority Data
Nov. 19, 2010 (CN) 201010552564.8

(51) Int. Cl. H04L 29/06

(52) U.S. Cl. CPC H04L 63/14
USPC 726/22

(57) ABSTRACT

The invention provides a cloud-based secure download method. A download terminal carries out an information interaction with a cloud security server via the Internet, comprising the following steps of: acquiring, by the download terminal, a URL address of a file to be downloaded by a user; comparing the URL address of the file to be downloaded with a malicious URL list in the cloud security server; and prompting a comparison result to the user by the download terminal.

### FIELD OF THE INVENTION

The invention relates to the field of computer security, and in particular to a cloud-based secure download method.

### BACKGROUND OF THE INVENTION

Nowadays detecting a virus by antivirus software is divided into nothing but two modes, namely, the traditional “feature library” scanning and active defense based on behavioral detection. And other technologies including heuristic virus scanning, virtual machine checking and killing virus, etc. may mostly be considered as a subdivision or branch of these two modes. Among them, the false alarms of the “feature library scanning” are minimal, but a fatal problem with it is its severe lag. Especially in the case of current Trojan variants increasing exponentially, the situations of missing virus killing and missing virus detection are very serious. Whereas as a behavioral detection mode, the active defense mainly detects a Trojan horse by a file behavior, so the greatest advantage of such mode is that it may abandon the feature library and realize a more intelligent Trojan detection. However, since the behavioral detection itself might produce a false detection, the phenomenon of false virus killing happens from time to time.

Considering the above-mentioned two modes, some forward-looking companies start to design a wholly new mode, namely, in which a large number of client computers are regarded as a virus collector, daily encountered suspicious files are uploaded to a server side by them, and thus the server may realize a quick response to a new virus by analyzing uploaded samples; while this is a kind of “cloud-based security”.

The security of downloaded files has been taken seriously by more and more people, and the policy of most products is to automatically perform virus killing after a file is downloaded in a first stage; if an antivirus software is installed on computer of user, then after a file is downloaded, the antivirus software will be automatically called to perform a virus scanning on the file. At a second stage, relevant virus checking and killing techniques will be applied to perform a quick scanning on the user's download environment. If a virus or a suspicious program is found, it will be automatically checked and killed or directly uploaded to a “cloud-based security” system for an automatic analysis and processing to guarantee the security of the user's download environment.

It can be seen from the above that current solutions can only perform a scan processing on a downloaded file, and for those virus or Trojan horse files downloaded consuming a lot of network resources, they may possibly be found and deleted only after the completion of execution of the download command. The solutions could do nothing about the content being downloaded.

### SUMMARY OF THE INVENTION

In view of this, the invention provides a cloud-based secure download method to solve the above problems.

In order to achieve the above objective, the invention provides a cloud-based secure download method, in which a download terminal carries out an information interaction with a cloud security server via the Internet, comprising the following steps of: acquiring, by the download terminal, a URL address of a file to be downloaded by a user; comparing the URL address of the file to be downloaded with a malicious URL list in the cloud security server; and prompting a comparison result to the user by the download terminal.

Preferably, the method further comprises: if the comparison result shows that there exists a security risk in the file to be downloaded and a download procedure for the file to be downloaded is initiated, issuing an instruction to terminate the download procedure by the download terminal.

Preferably, the step of comparing the URL address of the file to be downloaded with a malicious URL list in the cloud security server further comprises: uploading, by the download terminal, the URL address of the file to be downloaded to the cloud security server via the Internet and comparing the URL address with the malicious URL list by the cloud security server.

Preferably, the step of comparing the URL address of the file to be downloaded with a malicious URL list in the cloud security server further comprises: acquiring, by the download terminal, a latest malicious URL list from the cloud security server via the Internet and comparing, by the download terminal, the URL address with the malicious URL list locally.

Preferably, the malicious URL list in the cloud security server is acquired by the following processes: downloading a file via the download terminal by the user and recording the URL address of the file downloaded; scanning the file downloaded; writing the URL address of the file downloaded into the malicious URL list in the cloud security server if there exists a security risk in the file downloaded.

Preferably, the step of scanning the file downloaded further comprises: performing a scanning on the file downloaded by using a local virus library, or uploading, by the download terminal, the suspicious file to the cloud security server for scanning.

Preferably, the security risk comprises a virus, a Trojan horse, a malicious script, a malicious plug-in, software being poorly rated or rogue software.

Preferably, the comparison result is prompted to the user through a dialog box or a picture with text.

The invention further provides a cloud-based secure download terminal, which download terminal carries out an information interaction with a cloud security server via the Internet, the download terminal comprising:

a module adapted to acquiring a URL address of a file to be downloaded by a user;

a module adapted to comparing the URL address of the file to be downloaded with a malicious URL list in the cloud security server; and

a module adapted to prompting a comparison result to the user.

Preferably, the module adapted to comparing uploads the URL address of the file to be downloaded to the cloud security server via the Internet and the URL address is compared with the malicious URL list by the cloud security server.

Preferably, the module adapted to comparing acquires a latest malicious URL list from the cloud security server via the Internet and compares the URL address with the malicious URL list locally.

The invention further provides a computer readable recording medium having a program for performing the cloud-based secure download method recorded thereon.

By comparing a URL address of a file to be downloaded with a cloud security server, the embodiments provided by the invention may inform a user before downloading whether the file to be downloaded is secure or not. If a download procedure for the file to be downloaded is initiated, the invention also may timely terminate the download procedure and prompt the user.

### BRIEF DESCRIPTION OF THE DRAWINGS

FIG. 1 is a flow chart of a particular embodiment of a cloud-based secure download method of the invention;

FIG. 2 is a structural diagram of a particular embodiment of a cloud-based secure download terminal of the invention;

FIG. 3 is a schematic diagram of a particular embodiment of an application environment of the invention.

### DETAILED DESCRIPTION OF THE INVENTION

Since the understandings of the “cloud” by individual companies are not absolutely the same, there are great differences in what we finally see in the “cloud-based security”. Therein taken foreign antivirus software as a representative, processes in a computer of a user are marked mainly by a cluster of servers in the Internet, and those marked as trusted files will not take part in daily scanning, thereby the running speed of the daily scanning will be greatly increased. Such a design is similar to the “white list” that we are familiar with.

By contrast, in the Chinese antivirus softwares, each user client becomes a member of the “cloud-based security”, monitors abnormal behaviors of software in the network and automatically sends them to the server side for analyzing; after a slight processing, the processing scheme for a virus or Trojan horse will be distributed to each client; and thus any computer having antivirus software installed thereon may be able to implement a checking and killing for a new virus in a very short time.

However, in many cases, the user does not necessarily install antivirus software with the cloud functionality, and then how to protect the computer when the user is downloading a file becomes a problem which will be solved by the invention.

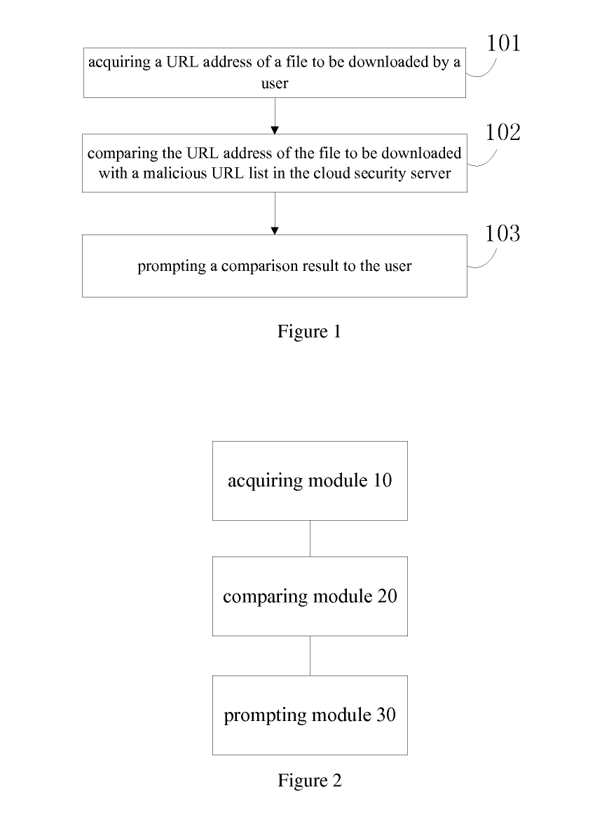

The invention provides a cloud-based secure download method, in which a download terminal carries out an information interaction with a cloud server (e.g., a cloud security server) via the Internet, in particular referring to what is shown in FIG. 1, comprising the following steps.

At step 101, acquiring, by the download terminal, a URL address of a file to be downloaded by a user.

Any kind of file to be downloaded from the network has its unique URL address, and even for a redirected address, what it finally directs to is its unique URL address. If a file corresponding to a URL address has been proven to be a malicious URL address, it should also be dangerous for anyone to download the file corresponding to the URL address. Although the possibility of the file corresponding to the URL address being replaced by a file without a virus cannot be excluded, such possibility is very low. Since those who deliberately destroy computer security just intend to let the opposite side infected with a virus, and either a Trojan horse or a virus is for the purpose of letting the opposite side infected with a virus, such possibility will hardly happen.

In other words, determining whether a file to be downloaded is secure or not by using its URL address is feasible.

In general, after a user clicks a download address, a page will give a prompt message about whether to download or not, and only after the user further clicks “Yes” or “No”, a real download procedure can begin. In the course of such an operation, when the user clicks the download address, the download terminal may acquire the URL address of the file clicked by the user to download.

It is needed to be noted that, said URL (Uniform Resource Locator) is just one form representative of the link address of a file to be downloaded, and furthermore, the link address of a file to be downloaded may also be represented by other information such as URI (Universal Resource Identifier), URN (Uniform Resource Name), etc., which all pertains to the protection scope of the invention.

At step 102, comparing the URL address of the file to be downloaded with a malicious URL list in the cloud security server.

The comparison operation may be performed on the download terminal, and may also be performed on the cloud security server side. In a particular embodiment, the download terminal uploads the URL address of the file to be downloaded to the cloud security server via the Internet and the URL address is compared with the malicious URL list by the cloud security server, and then the comparison result is returned to the download terminal by the cloud security server. In another particular embodiment, the download terminal acquires a latest malicious URL list from the cloud security server via the Internet, compares the URL address with the malicious URL list locally, and gets the comparison result.

The comparison of the URL address of the file to be downloaded with the malicious URL list in the cloud security server may be a full-text matching, and also may be a feature string matching.

On the cloud security server a malicious URL list is maintained for storing URL addresses of files which have been determined having a risk. The malicious URL list is jointly maintained by users connected to the cloud security server.

the malicious URL list in the cloud security server is acquired by the following steps.

At step 201, the user downloads a file via the download terminal and the URL address of the file downloaded is recorded by the download terminal;

At step 202, the file downloaded is scanned;

At step 203, the URL address of the file downloaded is written into the malicious URL list in the cloud security server if there exists a security risk in the file downloaded.

The security risk comprises a virus, a Trojan horse, a malicious script, a malicious plug-in, software being poorly rated or rogue software.

For the step of scanning the file downloaded by the download terminal, the scanning may be performed by using a local virus library in the download terminal, or the suspicious file may be uploaded to the cloud security server for scanning

When it is determined that the file downloaded has a security risk, if it is found locally by the download terminal, the URL address of the file downloaded is uploaded to the cloud security server and written into the malicious URL list; and if it is found by the cloud security server side, the cloud security server directly writes the URL of the file downloaded into the malicious URL list.

At step 103, prompting a comparison result to the user.

Such prompting the comparison result to the user may be that providing a corresponding prompt message according to the comparison result.

The comparison result comprises that the file to be downloaded is secure or has a security risk. When the file to be downloaded is secure, the user is prompted that the file can be downloaded in such a manner as a dialog box, a picture with text prompt, etc.

When it is detected that the file to be downloaded comprises a security risk, the user is informed that the file to be downloaded has a risk in such a manner as a dialog box, a picture with text prompt, etc.

As described previously, after a user clicks a download address, a page will give a prompt message about whether to download or not. In general, before the prompt message about whether to download or not is shown, the download terminal will prompt the user whether the file to be downloaded is secure or not, thereby providing a security basis for the user to select “Yes” or “No”.

However, in a particular embodiment, it takes time to compare by the cloud security server whether a link is secure or not. If the prompt message about whether to download or not is shown in advance, and the user has already clicked “Yes” to start the download of the file in this period of time, then it is unnecessary to check and kill virus in the file to be downloaded after the download is finished, but an instruction is directly issued by the download terminal to terminate the download procedure. As such, the security is greatly increased, and the infringement of a suspicious file on the system is thoroughly avoided.

Based on the above, the embodiments of the invention further provide a cloud-based secure download terminal, and in particular referring to what is shown in FIG. 2, the download terminal may comprise the following modules:

a module 10 adapted to acquiring a URL address of a file to be downloaded by a user, which may be briefly referred to as an acquiring module 10;

a module 20 adapted to comparing the URL address of the file to be downloaded with a malicious URL list in the cloud security server, which may be briefly referred to as a comparing module 20; and

a module 30 adapted to prompting a comparison result to the user, which may be briefly referred to as a prompting module 30.

Therein, the comparison operation may be performed in the download terminal, and may also be performed on the cloud security server side. Accordingly, if the comparison operation is performed on the download terminal, the comparing module 20 acquires a latest malicious URL list from the cloud security server via the Internet, and compares locally the URL address with the malicious URL list. If the comparison operation is performed on the cloud security server side, the comparing module 20 uploads the URL address of the file to be downloaded to the cloud security server via the Internet and the URL address is compared with the malicious URL list by the cloud security server.

Preferably, the comparison result may be prompted to the user through a dialog box or a picture with text.

Preferably, if the comparison result shows that there exists a security risk in the file to be downloaded and a download procedure for the file to be downloaded is initiated, the download terminal may further comprise a download terminating module adapted to issuing an instruction to terminate the download procedure.

Therein, the security risk comprises a virus, a Trojan horse, a malicious script, a malicious plug-in, software being poorly rated or rogue software.

For the embodiment of the cloud-based secure download terminal, its description is relatively simple due to it being substantially similar to the method embodiment, and what is relevant may be referred to the description for parts of the method embodiment as shown in FIG. 1.

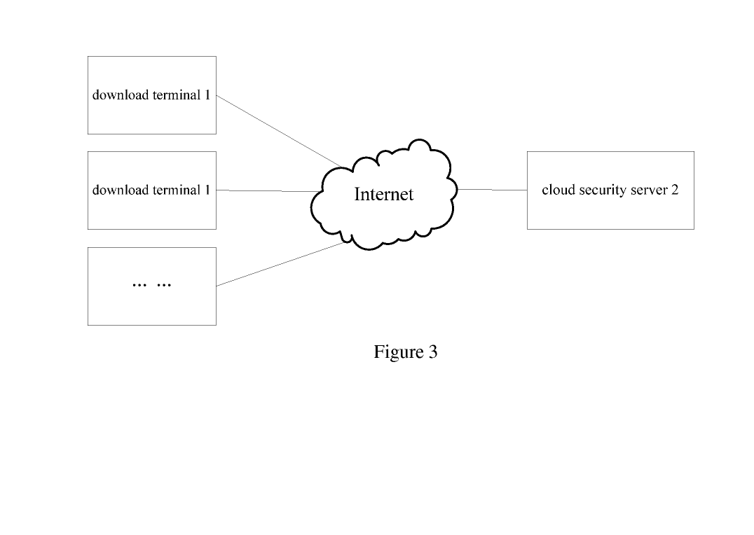

The download terminal may be applied to the following environment as shown in FIG. 3, which is an application environment based on cloud computation, and specifically as follows.

In this application environment, each download terminal 1 may carry out an information interaction with a cloud security server 2 via the Internet, and the individual download terminal 1 realizes a cloud-based secure download by way of an interaction with the cloud security server 2.

As described previously, the download terminal 1 may comprise an acquiring module 10, a comparing module 20 and a prompting module 30. In the cloud security server 2 a malicious URL list is stored, and in the list dangerous URL addresses is recorded. The comparing module 20 in the download terminal 1 may upload the URL address of the file to be downloaded to the cloud security server 2 via the Internet and the URL address is compared with the malicious URL list by the cloud security server 2. The comparing module 20 in the download terminal 1 may also acquire a latest malicious URL list from the cloud security server 2 via the Internet and compares locally the URL address with the malicious URL list.

Furthermore, the malicious URL list in the cloud security server may be acquired by the following approach: the user downloading a file via the download terminal 1 and recording the URL address of the file downloaded; scanning the file downloaded; writing the URL address of the file downloaded into the malicious URL list in the cloud security server 2 if there exists a security risk in the file downloaded.

Therein, the file downloaded may be scanned by utilizing a local virus library in the download terminal 1, or the suspicious file may be uploaded by the download terminal 1 to the cloud security server 2 for scanning.

Based on the above, the invention further provides a computer readable record medium having a program for performing the cloud-based secure download method recorded thereon. Therein, the particular content of the cloud-based secure download method may be referred to what is described in the embodiment in FIG. 1, and will not be repeated here.

The computer readable record medium comprises any mechanism which stores or transmits information in a machine (e.g., computer) readable form. For example, a machine readable medium comprises a read-only memory (ROM), a random access memory (RAM), a magnetic disk storage medium, an optical storage medium, a flash storage medium, a transmission signal in the form of electricity, light, sound or others (e.g., a carrier wave, an infrared signal, a digital signal, etc.), etc.

The invention may be used in numerous general-purpose or dedicated computing system environments or configurations, for example, a personal computer, a server computer, a handheld device or portable device, a tablet type device, a multi-processor system, a microprocessor based system, a set-top box, a programmable consumer electronic device, a network PC, a minicomputer, a large-scale computer, a distributed computing environment comprising any of the above systems or devices, etc.

The invention may be described in the context of a computer executable instruction executed by a computer, e.g., a program module. In general, the program module comprises a routine, program, object, component, data structure, etc. performing a specific task or implementing a specific abstract data type. The application may also be practiced in distributed computing environments, in which a task is performed by a remote processing device connected by a communications network. In a distributed computing environment, the program module may be located in a local and remote computer storage medium comprising a storage device.

In the invention, a “component”, “apparatus”, “system”, etc. refers to a relevant entity applied in a computer, for example, hardware, a combination of hardware and software, software, or software in execution, etc. In detail, for example, a component may be, but not limited to, a procedure running on a processor, a processor, an object, an executable component, an executing thread, a program and/or a computer. Further, an application program or script program running on a server, a server may be a component. One or more components may be in an executing procedure and/or thread, and components may be localized on a computer and/or distributed between two or more computers, and may be run by all kinds of computer readable medias. Components may also communicate with each other by way of a local and/or remote procedure according to a signal having one or more packets, for example, a signal from data interacting with another component in the local system, a distributed system, and/or interacting with other systems by way of signal in the network of the Internet.

What is described above is just preferred embodiments of the invention, not used for limiting the invention, and any modifications, equivalent substitutions, etc. made within the spirit and principle of the invention should all be embraced within the protection scope of the invention.

1. A cloud-based secure download method, wherein a download terminal carries out an information interaction with a cloud security server via the Internet, the method comprising the following steps of:
acquiring, by the download terminal, a URL address of a file to be downloaded by a user;
comparing the URL address of the file to be downloaded with a malicious URL list in the cloud security server; and
prompting a comparison result to the user by the download terminal.

2. The method as claimed in claim 1, characterized in that, the method further comprising:
if the comparison result shows that there exists a security risk in the file to be downloaded and a download procedure for the file to be downloaded is initiated, issuing an instruction to terminate the download procedure by the download terminal.

3. The method as claimed in claim 1, characterized in that, the step of comparing the URL address of the file to be downloaded with a dangerous list in the cloud security server further comprising:
uploading, by the download terminal, the URL address of the file to be downloaded to the cloud security server via the Internet; and
comparing the URL address with the dangerous list by the cloud security server.

4. The method as claimed in claim 1, characterized in that, the step of comparing the URL address of the file to be downloaded with a dangerous list in the cloud security server further comprising:
acquiring, by the download terminal, the latest malicious URL list from the cloud security server via the Internet; and
comparing, by the download terminal, the URL address with the latest malicious URL list locally.

5. The method as claimed in claim 1, characterized in that, the malicious URL list in the cloud security server is acquired by the following processes:
downloading a file via the download terminal by the user, and recording the URL address of the file downloaded;
scanning the file downloaded;
writing the URL address of the file downloaded into the malicious URL list in the cloud security server if there exists a security risk in the file downloaded.

6. The method as claimed in claim 5, characterized in that, the step of scanning the file downloaded further comprising:
performing a scanning on the file downloaded by utilizing a local virus library; or uploading, by the download terminal, the suspicious file downloaded to the cloud security server for scanning.

7. The method as claimed in claim 2, characterized in that, the security risk comprising a virus, a Trojan horse, a malicious script, a malicious plug-in, a software being poorly rated, or rogue software.

8. The method as claimed in claim 1, characterized in that, the comparison result is prompted to the user through a dialog box or a picture with text.

9. A cloud-based secure download terminal, wherein the download terminal carries out an information interaction with a cloud security server via the Internet, and the download terminal comprising:
a module adapted to acquiring a URL address of a file to be downloaded by a user;
a module adapted to comparing the URL address of the file to be downloaded with a malicious URL list in the cloud security server; and
a module adapted to prompting a comparison result to the user.

10. The download terminal as claimed in claim 9, characterized in that,
the module adapted to comparing uploads the URL address of the file to be downloaded to the cloud security server via the Internet and the URL address is compared with the malicious URL list by the cloud security server.

11. The download terminal as claimed in claim 9, characterized in that,
the module adapted to comparing acquires a latest malicious URL list from the cloud security server via the Internet and compares the URL address with the malicious URL list locally.

12. A computer readable record medium having a program for performing a method as claimed in claim 1 recorded thereon.

13. The method as claimed in claim 1, characterized in that in the cloud security server the malicious URL list is jointly maintained by users connected to the cloud security server, and URL addresses of files which have been determined having a risk are stored in the malicious URL list.
